(19) United States
(12) Patent Application Publication
(10) Pub. No.: US 2006/0120729 A1
(43) Pub. Date: Jun. 8, 2006

(54) Transmission system and method employing electrical return-to-zero modulation

(75) Inventors: Yu Sheng Bai, Los Altos Hills, CA (US); Fei Zhu, San Jose, CA (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: FutureWei Technologies, Inc., Plano, TX (US)

(21) Appl. No.: 11/004,404

(22) Filed: Dec. 3, 2004

(51) Int. Cl. H04B 10/12

(52) U.S. Cl. 398/199

(57) ABSTRACT

A system and method for transmitting a signal for optical network applications. The system includes an optical transmitter configured to output an optical signal. The optical signal is associated with a return-to-zero modulation. Additionally, the system includes an optical fiber transmission system coupled to the optical transmitter and configured to transmit the optical signal and output the transmitted optical signal. The optical transmitter includes a return-to-zero driver configured to receive at least a first data signal and generate a drive signal, a light source configured to generate a laser, and an electroabsorption modulator configured to receive the laser and the drive signal and generate the optical signal. Each of the first data signal and the drive signal is an electrical signal. The optical signal includes data associated with the return-to-zero modulation. The optical fiber transmission system is free from any dispersion compensation device.

### CROSS-REFERENCES TO RELATED APPLICATIONS

NOT APPLICABLE

### STATEMENT AS TO RIGHTS TO INVENTIONS MADE UNDER FEDERALLY SPONSORED RESEARCH OR DEVELOPMENT

NOT APPLICABLE

### REFERENCE TO A “SEQUENCE LISTING,” A TABLE, OR A COMPUTER PROGRAM LISTING APPENDIX SUBMITTED ON A COMPACT DISK.

NOT APPLICABLE

### BACKGROUND OF THE INVENTION

The present invention relates in general to telecommunication techniques. More particularly, the invention provides a method and system using an electroabsorption modulated laser (EML) with electrical return-to-zero (eRZ) modulation. Merely by way of example, the invention is described as it applies to optical networks, but it should be recognized that the invention has a broader range of applicability.

Telecommunication techniques have progressed through the years. As merely an example, optical networks have been used for conventional telecommunications in voice and other applications. The optical networks can transmit multiple signals of different capacities. For example, the optical networks terminate signals, multiplex signals from a lower speed to a higher speed, and/or from one wavelength to multiple wavelengths, switch signals, and transport signals in the networks according to certain definitions.

In modern optical communications, an optical signal is often transmitted over a long distance, such as hundreds of kilometers or more, in single mode optical fiber links. An important property of optical fibers is chromatic dispersion, which causes different spectral components of an optical pulse to travel at different speeds in the optical fibers. The chromatic dispersion can broaden the signal pulses and limit the transmission distance. For example, a standard single mode fiber (SSMF) has a chromatic dispersion of 17 ps/(nm×km) at a signal wavelength of 1550 nm. If the spectral bandwidth of the signal is 0.1 nm, the signal pulses would become 170 ps wider after a transmission distance of 100 km in SSMF.

For high-speed transmissions at over one gigabit per second, the bit periods are only a few hundred picoseconds, or even a few tens picoseconds; thus the spectrum broadening can significantly degrade the detectability of the signal. Accordingly, the chromatic dispersion often limits the transmission distance at a data rate equal to or higher than 2.5 gigabits per second (Gbps). For example, in a transform-limited case, the dispersion-limited distance for an optical signal at a data rate of 2.5 Gbps is about 1,100 kilometers (km) at a wavelength of 1550 nm in a standard single-mode fiber (SSMF) with 1-dB power penalty.

Additionally, the dispersion-limited distance can be adversely affected by chirp in a modulated optical signal. Chirp refers to an excursion of the carrier frequency during a data bit stream, such as during the sharp turn-on and turn-off transients at signal pulse edges. The frequency excursion is usually caused by phase variation incurred during data modulation and related to the time-dependent output signal power by:

$$Δ v = \frac{1}{2 π} ⨯ \frac{ⅆ ϕ ( t )}{ⅆ t} = \frac{α}{4 π} ⨯ \frac{ⅆ ln P ( t )}{ⅆ t} \qquad ( Equation 1 )$$

where α represents line width enhancement factor, also called chirp factor. The chirp factor is related to changes in the complex index of refraction.

Chirp can contribute to the spectral broadening of an optical signal, which in turn limits the transmission distance. Accordingly, a transmitter with directly modulated semiconductor laser (DML) is often considered unfit for high-speed long haul optical networks. The DML can generate an optical data signal with undesirably large chirp. As an alternative, a transmitter with an external modulator and a continuous wave (CW) diode laser is preferred at a data rate of 2.5 Gbps or higher for long haul optical transport.

The external modulator usually uses the electrooptic or electroabsorption effect. For example, a conventional electrooptic modulator employs a Mach-Zehnder (MZ) interferometer. The output from a CW diode laser is branched into two separate arms of almost equal path and then combined at the output. The electro-optic effect makes the propagation velocity in each arm depend on the voltage applied. Consequently, the combined optical signal may experience high (bit 0) or low (bit 1) loss depending on whether the two signals at the output are out-of-phase or in-phase respectively.

As another example, a conventional electroabsorption modulator (EAM) operates on the principle that the semiconductor band gap can be modulated as a function of reverse-biased voltage. The semiconductor band gap is related to the absorption edge of the modulator. Depending on the modulation voltage, the optical signal experiences high (bit 0) or low (bit 1) loss as the modulator absorption edge is shifted towards shorter or longer wavelength. The EAM may include bulk semiconductor or multiple quantum wells (MQWs). The conventional EAM with bulk semiconductor uses Franz-Keldysh effect, under which the edge of the semiconductor band gap broadens at high E-field and creates an absorptive tail at photon energy just below the gap. In contrast, the conventional MQW EAM uses quantum confined Stark effect (QCSE), under which excitons give rise to an enhanced absorption peak at the band edge.

The various types of conventional modulators each have strengths and weaknesses. For example, the conventional electrooptic modulator with MZ interferometer can provide almost chirp-free modulation and have low loss and high extinction ratio. But the MZ modulator is often bulky, expensive, and complicated to operate. Accordingly, a transmitter employing an MZ modulator is usually used in a long haul or extended long haul optical system for a bit rate of 10 Gbps or higher.

As another example, the conventional electroabsorption modulator can integrate with semiconductor laser and/or other opto-electric components on a single chip and thus form an integrated electroabsorption modulated laser (EML). The EML is usually inexpensive to make and small in size. As cost and size become increasingly important, the EML has the potential to become dominant solution for optical transport systems. But the conventional electroabsorption modulator suffers from significant drawbacks. For example, the conventional MQW EAM often requires a wavelength match between laser and electroabsorption, and thus limits the manufacturing yield. Additionally, the conventional MQW EAM often has an absorption peak that is wavelength dependent, and it is usually used for only a narrow wavelength range. In another example, the conventional Bulk EAM often has a large chirp factor that would limit the transmission distance of an optical signal.

Hence it is highly desirable to improve techniques for transmitting optical signals.

### BRIEF SUMMARY OF THE INVENTION

The present invention relates in general to telecommunication techniques. More particularly, the invention provides a method and system using an electroabsorption modulated laser (EML) with electrical return-to-zero (eRZ) modulation. Merely by way of example, the invention is described as it applies to optical networks, but it should be recognized that the invention has a broader range of applicability.

According to one embodiment of the present invention, a system for transmitting a signal for optical network applications includes an optical transmitter configured to output an optical signal. The optical signal is associated with a return-to-zero modulation. Additionally, the system includes an optical transmission system coupled to the optical transmitter and configured to transmit the optical signal and output the transmitted optical signal. The optical transmitter includes a return-to-zero driver configured to receive at least a first data signal and generate a drive signal, a light source configured to generate a laser, such as laser light, and an electroabsorption modulator configured to receive the laser, such as laser light, and the drive signal and generate the optical signal. Each of the first data signal and the drive signal is an electrical signal. The optical signal includes data associated with the return-to-zero modulation. The optical transmission system is free from any dispersion compensation fiber.

According to another embodiment of the present invention, a system for transmitting a signal for optical network applications includes an optical transmitter configured to output an optical signal. The optical signal is associated with a return-to-zero modulation. Additionally, the system includes an optical transmission system coupled to the optical transmitter and configured to transmit the optical signal and output the transmitted optical signal. The optical transmitter includes a return-to-zero driver configured to receive at least a first data signal and generate a drive signal, a light source configured to generate a laser, and an electroabsorption modulator configured to receive the laser and the drive signal and generate the optical signal. Each of the first data signal and the drive signal is an electrical signal. The optical signal includes data associated with the return-to-zero modulation. The optical transmission system is free from any dispersion compensation fiber. The optical signal is associated with a data rate, and the data rate is about 2.5 Gobs.

According to yet another embodiment of the present invention, a method for transmitting a signal for optical network applications includes generating an optical signal. The optical signal is associated with a return-to-zero modulation. Additionally, the method includes transmitting the optical signal and outputting the transmitted optical signal. The generating an optical signal includes receiving at least a first data signal, and generating a drive signal based on at least information associated with the first data signal. The drive signal is associated with the return-to-zero modulation. Additionally, the generating an optical signal includes generating a laser, such as laser light, and generating the optical signal based on at least information associated with the laser, such as laser light, and the drive signal. The generating the optical signal includes performing an electroabsorption modulation. Each of the first data signal and the drive signal is an electrical signal. The optical signal includes data associated with the return-to-zero modulation. The transmitting optical signal is free from performing a fiber-based dispersion compensation.

Many benefits are achieved by way of the present invention over conventional techniques. Some embodiments of the present invention provide superior performance with EMLs of fixed or tunable laser wavelength. As an example, with widely tunable 2.5-Gbps EML, optical signals under eRZ modulation can achieve error-free transmission over 400 kilometers with more than 5-dB OSNR margin without using any dispersion compensation or forward error correction (FEC). Such EML includes an EAM with bulk semiconductor. As another example, for EML with fixed or narrowly tunable wavelength, optical signals under eRZ modulation can achieve error-free transmission over 600 kilometers with more than 5-dB OSNR margin without using any dispersion compensation or FEC. Such EML includes an EAM with multiple quantum wells. In contrast, a conventional EML that includes EAM with bulk semiconductor can usually provide error-free transmission for only about 200 kilometers in single mode optical fiber. A conventional EML including EAM with multiple quantum wells can usually provide error-free transmission for only about 400 kilometers in single mode optical fiber. Certain embodiments of the present invention provide an optical transmitter that would enable wide utilization of 2.5-Gbps EMLs to optical transport systems without dispersion compensation beyond the conventional limit on transmission distance.

Some embodiments of the present invention reduce size and cost of optical transmitters at various data rates, such as 2.5 Gbps. As an example, for conventional NRZ EMLs including EAM with multiple quantum wells, it may be possible to cherry-pick a few units which give desirable chirp characteristics, but these units often incur high premium due to a low yield rate. As another example, for metro and regional optical transport systems, flexibility at low cost in compact size is the key to broadband development. Certain embodiments of the present invention eliminate the need for dispersion compensation at various data rates and over several hundred kilometers. Adding dispersion compensation modules may reduce chromatic dispersion related distortions and/or timing jitters, but would greatly increase costs and reduce network flexibility such as at add/drop sites. Therefore transmitters employing EMLs but requiring no dispersion compensation is highly desirable. For example, a transmitter according to one embodiment of the present invention can perform error-free transmission at data rate of 2.5 Gbps over several hundred kilometers of single mode fiber without using any dispersion compensation. Certain embodiments of the present invention provide eRZ modulation with an EML that can be tuned to operate at any wavelength grids in C band or L band for dense wavelength division multiplexing (DWDM). For example, an optical transmitter according to an embodiment of the present invention is used for reconfigurable DWDM optical networks.

Various additional objects, features and advantages of the present invention can be more fully appreciated with reference to the detailed description and accompanying drawings that follow.

### BRIEF DESCRIPTION OF THE DRAWINGS

FIG. 1 is a simplified diagram showing measured BER values as a function of OSNR;

FIGS. 2(a) and 2(b) are simplified diagram for comparing measured chirp profiles under NRZ modulation according to an embodiment of the present invention;

FIGS. 3(a) and 3(b) are simplified diagram for comparing measured chirp profiles under eRZ modulation according to an embodiment of the present invention;

FIG. 4 is a conventional transmitter with NRZ modulation;

FIG. 5 is a simplified transmitter with eRZ modulation according to an embodiment of the present invention;

FIG. 6 is a simplified wavelength division multiplexing (WDM) transmission system according to an embodiment of the present invention;

FIG. 7 is a simplified wavelength division multiplexing (WDM) transmission system according to another embodiment of the present invention;

FIG. 8 is a simplified transmission system for synchronous optical network (SONET) according to yet another embodiment of the present invention;

FIG. 9 is a simplified diagram showing measured BER as a function of OSNR for an optical signal under eRZ modulation according to an embodiment of the present invention;

FIG. 10 is a simplified diagram showing measured BER as a function of OSNR according to another embodiment of the present invention.

### DETAILED DESCRIPTION OF THE INVENTION

The present invention relates in general to telecommunication techniques. More particularly, the invention provides a method and system using an electroabsorption modulated laser (EML) with electrical return-to-zero (eRZ) modulation. Merely by way of example, the invention is described as it applies to optical networks, but it should be recognized that the invention has a broader range of applicability.

For a conventional EML, the non-return-to-zero (NRZ) modulation is usually applied. The NRZ modulation is perceived conventionally as being more tolerant to chromatic dispersion than RZ modulation because the NRZ modulation has a narrower spectrum. For example, a chirp-free transform-limited NRZ data pulse can give rise to a spectral width of 0.013 nm at 2.5 Gbps and 1550 nm based on the second moment calculation. Such chirp-free NRZ signal can theoretically tolerate a maximum chromatic dispersion of 18,820 ps/nm at 1-dB power penalty. This maximum dispersion tolerance corresponds to a transmission distance of about 1100 kilometers if the transmission fiber has a dispersion coefficient of 17 ps/nm-km at 1550 nm. The NRZ modulation as discussed above can be implemented by an electroabsorption modulator (EAM). The EAM may add a peak-to-peak (p-p) frequency chirp of 3 GHz, which would dominate the spectral width of the NRZ data and increase the spectral width to 0.027 nm. Correspondingly, the dispersion-limited distance would be reduced theoretically to about 500 km.

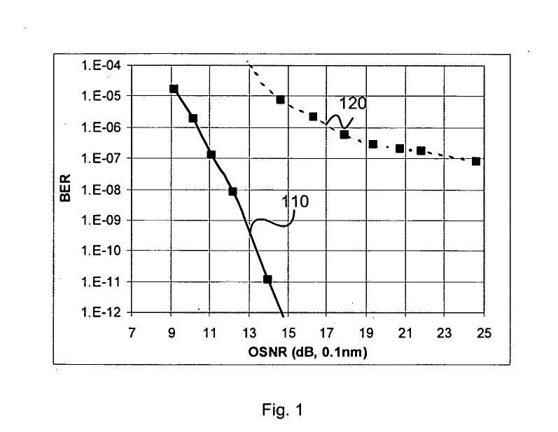

To compare with the theoretical calculation, the bit error rate (BER) has been measured as a function of optical-signal-to-noise ratio (OSNR) for an optical signal at 2.5 Gbps and 1560 nm. In one embodiment, the fiber dispersion at 1560 nm is substantially the same as the fiber dispersion at 1550 nm. The optical signal carries pseudo random bit sequences under NRZ modulation and is generated by an electroabsorption modulated laser (EML). Such random bit sequences each have a length of 2³¹-1 bits and are referred to as PRBS 2³¹-1. PRBS 2³¹-1 is used to emulate real-word data patterns. The EML includes a tunable laser source and an EAM with bulk semiconductor. FIG. 1 is a simplified conventional diagram showing such measured BER values as a function of OSNR. Curves 110 and 120 correspond to the optical signal before and after its transmission respectively. The transmission is carried out in a single mode fiber of 400 kilometers, which has a dispersion coefficient of about 17.6 ps/nm-km at 1560 nm. As shown in FIG. 1, the curve 120 displays a BER floor at about 1×10⁻⁷, which is much higher than 1×10⁻¹² for error-free transmission. Hence after only about 400 kilometers, the optical signal under NRZ modulation is severely distorted. An error-free transmission cannot be achieved without resolving to dispersion compensation.

The experimental distance of less than 400 kilometers is inconsistent with the theoretical prediction of at least 500 kilometers for error-free transmission. This inconsistency may result from some distortions to the NRZ data during its transmission, but these distortions cannot be explained simply by Equation 1. The inventors have discovered that the dependence of chirp on bit pattern can cause additional distortions to the NRZ data and therefore severely reduce the dispersion-limited transmission distance. In other words, contrary to the conventional perception, it is not the chirp itself but the pattern-dependent chirp variations that causes dominant distortions and thus the excessively large penalty.

For EML with NRZ modulation, the chirp factor is dependent on bias voltage. For example, an EML includes an EAM with bulk semiconductor, and its chirp factor approaches zero only when the bias voltage becomes negative with large absolute magnitude. During data modulation, the bias voltage often varies with the drive voltage. Accordingly, under large signal modulation such as NRZ modulation, the chirp factor can vary widely in response to full swing of the drive voltage. For example, the chirp factor changes from 0.9 to 0 when the drive voltage swings from −1 volts to −5 volts and the data bit changes from 1 and 0. Hence the chirp factor as well as the chirp depends significantly on data bit pattern. As an example, the chirp of bit stream 1111101011 should be significantly different from the chirp of bit stream 1010101010.

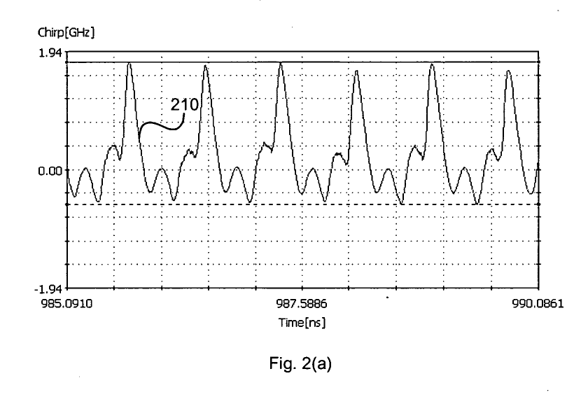

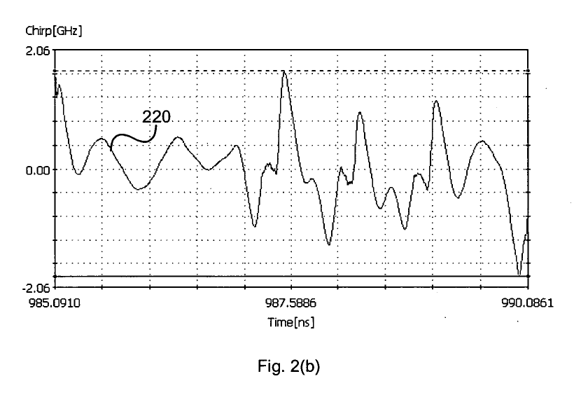

FIGS. 2(a) and 2(b) are simplified diagram for comparing measured chirp profiles under NRZ modulation according to an embodiment of the present invention. This diagram is merely an example, which should not unduly limit the scope of the claims. One of ordinary skill in the art would recognize many variations, alternatives, and modifications. As shown in FIGS. 2(a) and 2(b), chirp profiles have been measured for an optical signal with NRZ modulation at 2.5 Gbps and 1560 nm. The optical signal is generated by a tunable EML including EAM with bulk semiconductor. A curve 210 corresponds to bit stream 1010101010, and a curve 220 corresponds to bit stream 1111101011. For bit stream 1010101010, the peak-to-peak chirp is about 2.04 GHz, but for bit stream 1111101011, the peak-to-peak chirp is about 3.01 GHz. Hence the chirp for NRZ data modulation depends strongly on bit pattern. Accordingly, signals of different data patterns may acquire different phases during transmission, which result in timing jitters at receiver and additional penalty to signal quality.

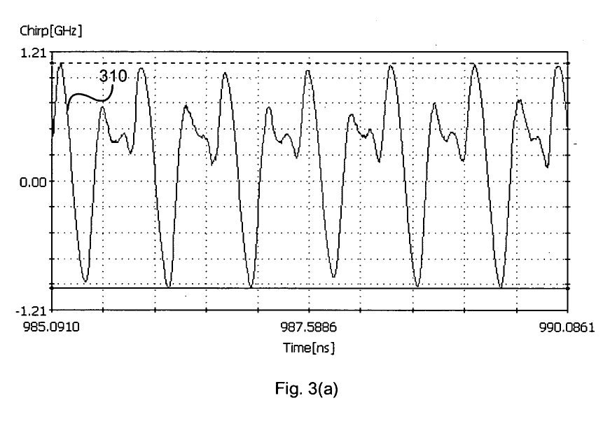

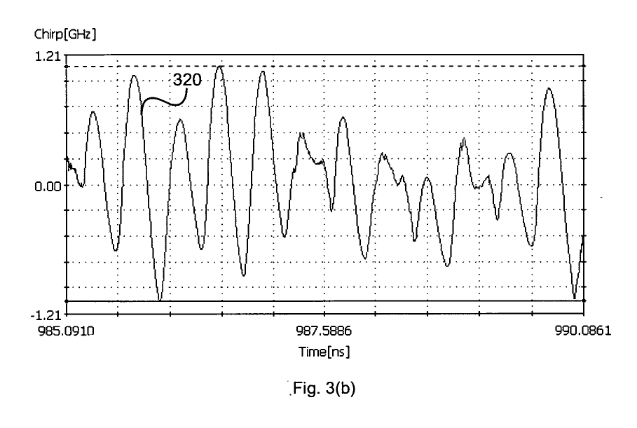

In contrast to NRZ modulation, the inventors have discovered that eRZ modulation usually does not produce any significant phase differences or additional penalty after transmission. FIGS. 3(a) and 3(b) are simplified diagram for comparing measured chirp profiles under eRZ modulation according to an embodiment of the present invention. This diagram is merely an example, which should not unduly limit the scope of the claims. One of ordinary skill in the art would recognize many variations, alternatives, and modifications. As shown in FIGS. 3(a) and 3(b), chirp profiles have been measured for an optical signal with eRZ modulation at 2.5 Gbps and 1560 nm. The optical signal is generated by a tunable EML including EAM with bulk semiconductor. A curve 310 corresponds to bit stream 1010101010, and a curve 320 corresponds to bit stream 1111101011. For bit stream 1010101010, the peak-to-peak chirp is about 2.08 GHz, and for bit stream 1111101011, the peak-to-peak chirp is about 2.12 GHz. Hence the chirp for RZ data modulation does not depend strongly on bit pattern. Accordingly, signals of different data patterns can acquire substantially the same phase during transmission without suffering from any significant additional penalty to signal quality. Consequently, an EML may benefit from using the eRZ modulation instead of the NRZ modulation. The EML can be used in an optical transmitter with improved dispersion-limited distance.

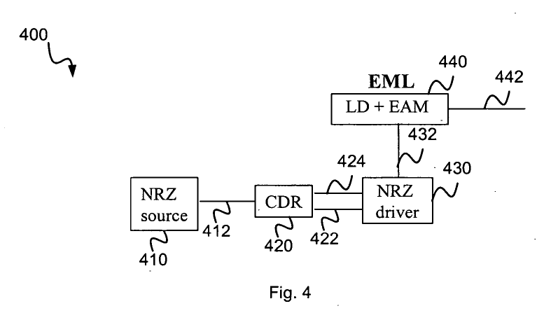

FIG. 4 is a conventional transmitter with NRZ modulation. A transmitter 400 includes an NRZ source 410, a clock-data recovery device (CDR) 420, an NRZ diver 430, and an EML 440. The EML 440 includes a laser diode and an EAM. The NRZ source 410 generates a data signal 412 in the NRZ format. The data signal 412 is received and re-conditioned by the CDR 420. The CDR 420 generates a data signal 422 and a clock signal 424, which are received by the NRZ driver 430. The NRZ driver 430 amplifies the data signal 422 and output a drive signal 432. The drive signal 432 is received by the EAM of the EML 440. The EAM converts the laser generated by the laser diode into an optical signal 442. The optical signal 442 carries the data generated by the data source 410 and encoded in the NRZ format.

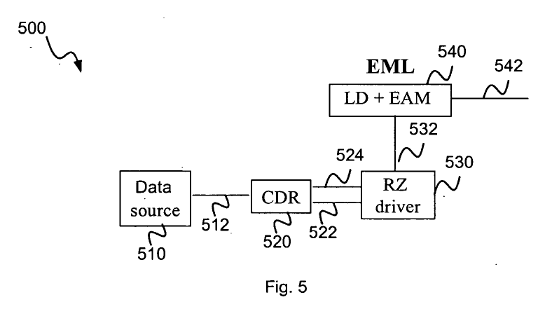

FIG. 5 is a simplified transmitter with eRZ modulation according to an embodiment of the present invention. This diagram is merely an example, which should not unduly limit the scope of the claims. One of ordinary skill in the art would recognize many variations, alternatives, and modifications. A transmitter 500 includes a data source 510, a clock-data recovery device (CDR) 520, a RZ diver 530, and an EML 540. Although the above has been shown using a selected group of apparatuses for the transmitter 500, there can be many alternatives, modifications, and variations. For example, some of the apparatuses may be expanded and/or combined. Other apparatuses may be inserted to those noted above. Depending upon the embodiment, the arrangement of apparatuses may be interchanged with others replaced. The transmitter 500 has various applications, such as for an optical transport system. Further details of these apparatuses are found throughout the present specification and more particularly below.

The EML 540 includes a laser diode and an EAM. As an example, the laser diode is a CW laser diode, and the EML includes bulk semiconductor or multiple quantum wells. For an EML with multiple quantum wells, the CW laser diode may have a substantially fixed laser wavelength. For an EML with bulk semiconductor, the CW laser diode may have a tunable laser wavelength. In one embodiment, the laser diode and the EAM are integrated onto the same chip. The data source 510 generates a data signal 512 in various encoding formats, such as the NRZ format. For example, the data signal 512 is an electrical signal. The data signal 512 is received and re-conditioned by the CDR 520. The CDR 520 generates a data signal 522 and a clock signal 524, which are received by the RZ driver 530. The RZ driver 530 amplifies the data signal 522 and output a drive signal 532. The drive signal 532 is received by the EAM of the EML 540. The EAM converts the laser generated by the laser diode into an optical signal 542. The optical signal 542 carries the data generated by the data source 510 and encoded in the RZ format.

As discussed above, the signals 522, 524 and 532 are all electrical signals, and the RZ driver performs an electrical return-to-zero (eRZ) modulation. The generated electrical signal 532 is converted to the optical signal 542 by the EML 540. Accordingly, the optical signal 542 is an eRZ modulated signal.

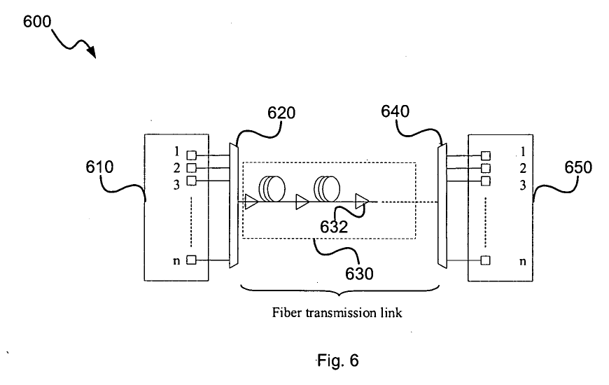

FIG. 6 is a simplified wavelength division multiplexing (WDM) transmission system according to an embodiment of the present invention. This diagram is merely an example, which should not unduly limit the scope of the claims. One of ordinary skill in the art would recognize many variations, alternatives, and modifications. A system 600 includes optical transmitters 610, a WDM multiplexer 620, a transmission line system 630, a WDM demultiplexer 640, and optical receivers 650. Although the above has been shown using a selected group of apparatuses for the transmission system 600, there can be many alternatives, modifications, and variations. For example, some of the apparatuses may be expanded and/or combined. Other apparatuses may be inserted to those noted above. Depending upon the embodiment, the arrangement of apparatuses may be interchanged with others replaced. Further details of these apparatuses are found throughout the present specification and more particularly below.

The optical transmitters 610 includes optical transmitters 1, 2, . . . , n, where n is a positive integer. In one embodiment, each of the optical transmitters 610 is the optical transmitter 500 including the RZ driver 530 as shown in FIG. 5. The optical transmitters 610 are connected to the WDM multiplexer 620. The multiplexer 620 receives outputs of the optical transmitters 610 in eRZ encoding and generates a multiplexed optical signal which is also eRZ modulated. The multiplexed optical signal is transmitted via the transmission line system 630. The transmission line system 630 includes multiple spans and multiple optical amplifier systems 632. In one embodiment, each optical amplifier system is placed between each pair of adjacent spans. The multiplexed optical signal is received by the WDM demultiplexer 640 which generates optical signals. The optical signals are eRZ modulated and received by the optical receivers 650 including optical receivers 1, 2, . . . , n and corresponding to the optical transmitters 610 respectively. n is a positive integer. At each of the optical receivers 650, the received optical signal is converted to an electrical signal. The electrical signal is sent to a clock-data recovery system, which eliminates or reduces signal distortions and jitters resulting from the optical fiber transmission.

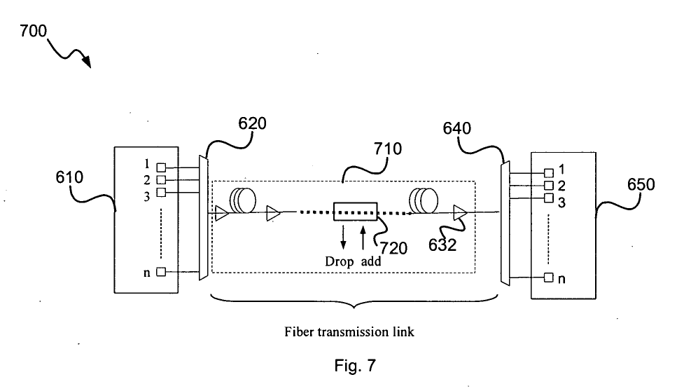

FIG. 7 is a simplified wavelength division multiplexing (WDM) transmission system according to another embodiment of the present invention. This diagram is merely an example, which should not unduly limit the scope of the claims. One of ordinary skill in the art would recognize many variations, alternatives, and modifications. A system 700 includes optical transmitters 610, a WDM multiplexer 620, a transmission line system 730, a WDM demultiplexer 640, and optical receivers 650. The transmission line system 730 includes multiple spans and multiple optical amplifier systems 632. Additionally, the transmission line system 730 includes an add and drop system 720 for adding or dropping an optical signal. The transmission line system receives a multiplexed optical signal in eRZ modulation from the WDM multiplexer 620 and outputs a multiplexed optical signal also in eRZ modulation to the WDM demultiplexer 640.

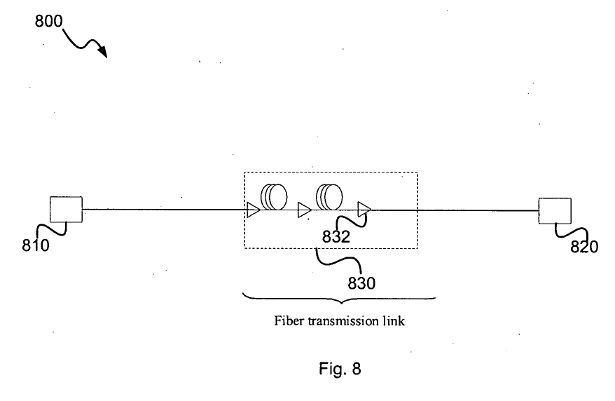

FIG. 8 is a simplified transmission system for synchronous optical network (SONET) according to yet another embodiment of the present invention. This diagram is merely an example, which should not unduly limit the scope of the claims. One of ordinary skill in the art would recognize many variations, alternatives, and modifications. A system 800 includes an optical transmitter 810, an optical receiver 820, and a transmission line system 830. Although the above has been shown using a selected group of apparatuses for the transmission system 800, there can be many alternatives, modifications, and variations. For example, some of the apparatuses may be expanded and/or combined. Other apparatuses may be inserted to those noted above. Depending upon the embodiment, the arrangement of apparatuses may be interchanged with others replaced. Further details of these apparatuses are found throughout the present specification and more particularly below.

The optical transmitter 810 includes the optical transmitter 500 with the RZ driver 530 as shown in FIG. 5. The optical transmitter 810 provides to the transmission line system 830 an optical signal with eRZ modulation. The optical signal is transmitted via the transmission line system 830. The transmission line system 830 includes multiple spans and multiple optical amplifier systems 832. In one embodiment, each optical amplifier system is placed between each pair of adjacent spans. The transmitted optical signal remains eRZ modulated and is received by the optical receiver 820. At the optical receivers 820, the received optical signal is converted to an electrical signal. The electrical signal is sent to a clock-data recovery system, which eliminates or reduces signal distortions and jitters resulting from the optical fiber transmission.

As discussed above and further emphasized here, FIGS. 6, 7, and 8 are merely examples, which should not unduly limit the scope of the claims. One of ordinary skill in the art would recognize many variations, alternatives, and modifications. For example, the transmitter 500 can be applied to various optical transport systems. The optical transport systems may include a wavelength division multiplexing (WDM) transmission system, a dense wavelength division multiplexing (DWDM) transmission system, a synchronous optical network (SONET) transmission system, and/or a synchronous digital hierarchy (SDH) transmission system. In contrast, a conventional transmission system may replace each of the eRZ optical transmitters 610 or the eRZ optical transmitter 810 with the NRZ transmitter 400 as shown in FIGS. 6, 7, and 8.

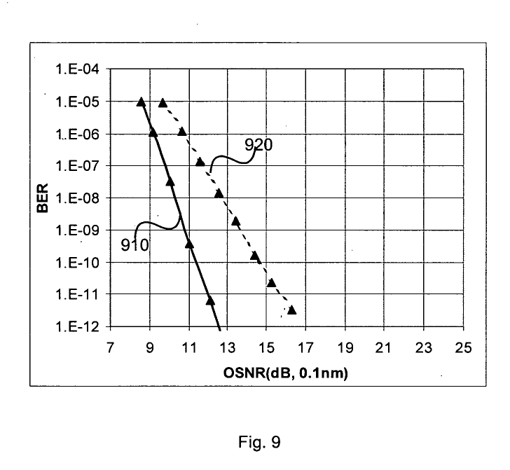

FIG. 9 is a simplified diagram showing measured BER as a function of OSNR for an optical signal under eRZ modulation according to an embodiment of the present invention. This diagram is merely an example, which should not unduly limit the scope of the claims. One of ordinary skill in the art would recognize many variations, alternatives, and modifications. The optical signal is generated by an EML and carries pseudo random bit sequences under eRZ modulation at 2.5 Gbps and 1560 nm. In one embodiment, the fiber dispersion at 1560 nm is substantially the same as the fiber dispersion at 1550 nm. Such random bit sequences each have a length of 2³¹-1 bits and are referred to as PRBS 2³¹-1. PRBS 2³¹-1 is used to emulate real-word data patterns. The EML includes a tunable laser source and an EAM with bulk semiconductor. The optical signal is transmitted for 400 kilometers in a single mode fiber, which has a dispersion coefficient of about 17.6 ps/nm-km at 1560 nm. As shown in FIG. 9, curves 910 and 920 represents the measured BER values before and after the optical signal being transmitted respectively. The curve 920 indicates that the transmitted signal has an BER value lower than 1×10⁻¹² for error-free transmission if OSNR is larger than 17 dB. In contrast to FIG. 1, an error-free transmission can be achieved under eRZ modulation without resolving to dispersion compensation. Dispersion compensation can be accomplished by one or more dispersion compensation devices. For example, the dispersion compensation devices include dispersion compensation fibers. In another example, the dispersion compensation devices may provide chromatic dispersion of opposite sign and thus cancel or compensate the chromatic dispersion of a transmission fiber link.

For example, as shown in FIG. 6, the launch power is 4 dBm per channel from each of the optical transmitters 610. The signal attenuation is about 23 dB for each optical span, which is about 80-kilometer long. The noise figure (NF) for each of the optical amplifiers 632 is about 6 dB. Accordingly, the signal OSNR after 5 spans would be at least 25 dB. Hence the eRZ transmitters with bulk-semiconductor EAM can provide a BER lower than 1×10⁻¹² and an OSNR margin higher than 8 dB without requiring dispersion compensation. In contrast, a conventional transmission system may replace each of the eRZ optical transmitters 610 with the NRZ transmitter 400. But FIG. 1 shows that the conventional NRZ transmitters with bulk-semiconductor EAM cannot provide a BER lower than 1×10⁻¹² and an OSNR margin higher than 8 dB without requiring dispersion compensation.

Therefore the eRZ modulation performs better than the NRZ modulation with bulk-semiconductor EAM according to some embodiments of the present invention. One reason for such superior performance is that the eRZ modulation usually does not incur any significant penalty resulting from pattern-dependent chirp variations as shown in FIGS. 2(a), 2(b), 3(a), and 3(b). Similar performance advantage of the eRZ modulation over the NRZ modulation has also been observed with fixed-wavelength EML including an EAM with multiple quantum wells.

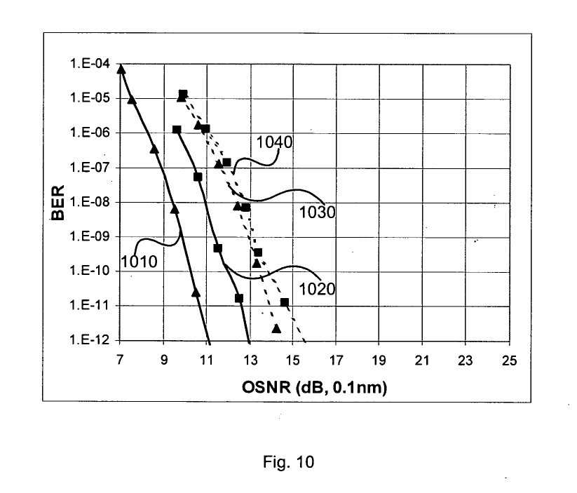

FIG. 10 is a simplified diagram showing measured BER as a function of OSNR according to another embodiment of the present invention. This diagram is merely an example, which should not unduly limit the scope of the claims. One of ordinary skill in the art would recognize many variations, alternatives, and modifications. The optical signal is modulated with simple alternating 1010 bit stream by an EML at 2.5 Gbps and 1560 nm. In one embodiment, the fiber dispersion at 1560 nm is substantially the same as the fiber dispersion at 1550 nm. The EML includes a tunable laser source and an EAM with bulk semiconductor. The optical signal is transmitted for 400 kilometers in a single mode fiber, which has a dispersion coefficient of about 17.6 ps/nm-km at 1560 nm.

As shown in FIG. 10, curves 1010 and 1030 correspond to an optical signal under eRZ modulation, and curves 1020 and 1040 correspond to an optical signal under NRZ modulation. The curves 1010 and 1020 are associated with the measured BER values prior to optical fiber transmission, and the curves 1030 and 1040 are associated with the measured BER values after 400-kilometer transmission. A comparison between the curves 1030 and 1040 shows that the NRZ modulation performs as well as the eRZ modulation with simple 1010 bit stream. So it is the pattern-dependent chirp variation that is intrinsic to an EML under NRZ modulation that causes significant distortions to the optical signals carrying real data instead of simple 1010 bit stream.

For an optical transport system, signal degradation due to optical fiber transmission can be measured by the amount of additional OSNR required to achieve the same BER performance as that prior to optical fiber transmission. This amount of additional OSNR is also called the OSNR penalty. As shown FIGS. 1, 9 and 10, the OSNR penalty under NRZ or eRZ for 400-kilometer transmission can be determined in case of PRBS 2³¹-1 or simple alternating 1010 bit stream.

Specifically for PRBS 2³¹-1 at BER of 10⁻⁵, the NRZ modulation incurs 5-dB OSNR penalty as compared to 1.5-dB OSNR penalty for the eRZ modulation. For simple alternating 1010 bit stream at BER of 10^{-5,} the NRZ modulation incurs 1-dB OSNR penalty while the eRZ modulation suffers from 2-dB OSNR penalty. Hence, for eRZ modulation the penalty in case of PRBS 2³¹-1 is very similar to the penalty for simple alternating 1010 bit stream. In contrast, for NRZ modulation, the penalty in case of PRBS 2³¹-1 is much larger than the penalty for simple alternating 1010 bit stream. The extra OSNR penalty of 3.6 dB results from timing jitters caused by pattern-dependent chirp variations.

In summary, according to certain embodiments of the present invention, the OSNR penalty due to fiber chromatic dispersion includes a first penalty component depending on the size of chirp and a second penalty component determined by variation of chirp. The second penalty component is much larger than the first penalty component for NRZ modulation but is negligible for eRZ modulation. In one embodiment, due to the negligible second pattern-related penalty component, eRZ modulation improves transmission distance by at least 50% over NRZ modulation.

The present invention has various advantages over conventional techniques. Some embodiments of the present invention provide superior performance with EMLs of fixed or tunable laser wavelength. As an example, with widely tunable 2.5-Gbps EML, optical signals under eRZ modulation can achieve error-free transmission over 400 kilometers with more than 5-dB OSNR margin without using any dispersion compensation or forward error correction (FEC). Such EML includes an EAM with bulk semiconductor. As another example, for EML with fixed or narrowly tunable wavelength, optical signals under eRZ modulation can achieve error-free transmission over 600 kilometers with more than 5-dB OSNR margin without using any dispersion compensation or FEC. Such EML includes an EAM with multiple quantum wells. In contrast, a conventional EML that includes EAM with bulk semiconductor can usually provide error-free transmission for only about 200 kilometers in single mode optical fiber. A conventional EML including EAM with multiple quantum wells can usually provide error-free transmission for only about 400 kilometers in single mode optical fiber. Certain embodiments of the present invention provide an optical transmitter that would enable wide utilization of 2.5-Gbps EMLs to optical transport systems without dispersion compensation beyond the conventional limit on transmission distance.

Some embodiments of the present invention reduce size and cost of optical transmitters at various data rates, such as 2.5 Gbps. As an example, for conventional NRZ EMLs including EAM with multiple quantum wells, it may be possible to cherry-pick a few units which give desirable chirp characteristics, but these units often incur high premium due to a low yield rate. As another example, for metro and regional optical transport systems, flexibility at low cost in compact size is the key to broadband development. Certain embodiments of the present invention eliminate the need for dispersion compensation at various data rates and over several hundred kilometers. Adding dispersion compensation modules may reduce chromatic dispersion related distortions and/or timing jitters, but would greatly increase costs and reduce network flexibility such as at add/drop sites. Therefore transmitters employing EMLs but requiring no dispersion compensation is highly desirable. For example, a transmitter according to one embodiment of the present invention can perform error-free transmission at data rate of 2.5 Gbps over several hundred kilometers of single mode fiber without using any dispersion compensation. Certain embodiments of the present invention provide eRZ modulation with an EML that can be tuned to operate at any wavelength grids in C band or L band for dense wavelength division multiplexing (DWDM). For example, an optical transmitter according to an embodiment of the present invention is used for reconfigurable DWDM optical networks.

Although specific embodiments of the present invention have been described, it will be understood by those of skill in the art that there are other embodiments that are equivalent to the described embodiments. Accordingly, it is to be understood that the invention is not to be limited by the specific illustrated embodiments, but only by the scope of the appended claims.

What is claimed is:

1. A system for transmitting a signal for optical network applications, the system comprising:
an optical transmitter configured to output an optical signal, the optical signal being associated with a return-to-zero modulation;
an optical transmission system coupled to the optical transmitter and configured to transmit the optical signal and output the transmitted optical signal;
wherein the optical transmitter includes:
a return-to-zero driver configured to receive at least a first data signal and generate a drive signal;
a light source configured to generate a laser;
an electroabsorption modulator configured to receive the laser and the drive signal and generate the optical signal;
wherein each of the first data signal and the drive signal is an electrical signal;
wherein the optical signal includes data associated with the return-to-zero modulation;
wherein the optical transmission system is free from any dispersion compensation fiber.

2. The system of claim 1 wherein the optical transmission system is free from any dispersion compensation device.

3. The system of claim 1 wherein:
the optical transmission system includes an optical fiber associated with a fiber length;
the optical signal traverses over the optical fiber;
the transmitted optical signal is associated with a chirp;
the chirp includes a first chirp component related to a signal distortion and a second chirp component related to a timing jitter.

4. The system of claim 3 wherein the electroabsorption modulator comprises bulk semiconductor.

5. The system of claim 4 wherein the fiber length is at least 400 kilometers.

6. The system of claim 5 wherein the optical signal is associated with a data rate, the data rate being about 2.5 Gbps.

7. The system of claim 3 wherein the electroabsorption modulator comprises a plurality of quantum wells.

8. The system of claim 7 wherein the fiber length is at least 600 kilometers.

9. The system of claim 8 wherein the optical signal is associated with a data rate, the data rate being about 2.5 Gbps.

10. The system of claim 1, and further comprising an optical receiver coupled to the optical transmission system and configured to receive the transmitted optical signal.

11. The system of claim 1 wherein the optical transmitter further comprises:
a data source configured to generate a second data signal;
a clock and data recovery system configured to receive the second data signal and generate at least the first data signal.

12. A system for transmitting a signal for optical network applications, the system comprising:
an optical transmitter configured to output an optical signal, the optical signal being associated with a return-to-Zero modulation;
an optical transmission system coupled to the optical transmitter and configured to transmit the optical signal and output the transmitted optical signal;
wherein the optical transmitter includes:
a return-to-zero driver configured to receive at least a first data signal and generate a drive signal;
a light source configured to generate a laser;
an electroabsorption modulator configured to receive the laser and the drive signal and generate the optical signal;
wherein each of the first data signal and the drive signal is an electrical signal;
wherein the optical signal includes data associated with the return-to-zero modulation;
wherein the optical fiber transmission system is free from any dispersion compensation fiber;
wherein the optical signal is associated with a data rate, the data rate being about 2.5 Gbps.

13. The system of claim 12 wherein the optical fiber transmission system is free from any dispersion compensation device.

14. A method for transmitting a signal for optical network applications, the method comprising:
generating an optical signal, the optical signal being associated with a return-to-zero modulation;
transmitting the optical signal;
outputting the transmitted optical signal;
wherein the generating an optical signal includes:
receiving at least a first data signal;
generating a drive signal based on at least information associated with the first data signal, the drive signal being associated with the return-to-zero modulation;
generating a laser;
generating the optical signal based on at least information associated with the laser and the drive signal;
wherein the generating the optical signal includes performing an electroabsorption modulation;
wherein each of the first data signal and the drive signal is an electrical signal;
wherein the optical signal includes data associated with the return-to-zero modulation;
wherein the transmitting the optical signal is free performing any fiber-based dispersion compensation.

15. The method of claim 14 wherein the transmitting the optical signal is free performing any dispersion compensation.

16. The method of claim 14 wherein:
the transmitting the optical signal is associated with a transmission distance over an optical fiber;
the transmitting the optical signal includes transmitting the optical signal over the optical fiber;
the transmitted optical signal is associated with a chirp;
the chirp includes a first chirp component related to a signal distortion and a second chirp component related to a timing jitter.

17. The method of claim 16 wherein the electroabsorption modulation uses bulk semiconductor.

18. The method of claim 17 wherein the transmission distance is at least 400 kilometers.

19. The method of claim 18 wherein the optical signal is associated with a data rate, the data rate being about 2.5 Gobs.

20. The method of claim 16 wherein the electroabsorption modulation uses a plurality of quantum wells.

21. The method of claim 20 wherein the transmission distance is at least 600 kilometers.

22. The method of claim 21 wherein the optical signal is associated with a data rate, the data rate being about 2.5 Gobs.

23. The method of claim 14, and further comprising receiving the transmitted optical signal.

24. The method of claim 14 wherein the generating an optical signal comprises:
generating a second data signal;
receiving the second data signal;
generating at least the first data signal based on at least information associated with the second data signal.
